(19) United States
(12) Patent Application Publication
(10) Pub. No.: US 2014/0066206 A1
(43) Pub. Date: Mar. 6, 2014

(54) Controller Input for Interactive Gaming System

(71) Applicant: Playhouse Entertainment Inc., Winnipeg (CA)

(72) Inventor: Brett Gale, Winnipeg (CA)

(21) Appl. No.: 14/018,763

(22) Filed: Sep. 5, 2013

Related U.S. Application Data
(60) Provisional application No. 61/696,896, filed on Sep. 5, 2012.
(60) Provisional application No. 61/731,805, filed on Nov. 30, 2012.

(51) Int. Cl. A63F 13/06

(52) U.S. Cl. CPC A63F 13/06
USPC 463/37

(57) ABSTRACT

A control system for an interactive gaming system has a pair of controller assemblies for being supported in respective hands of the game participant. Each controller assembly includes a first housing locating motion tracking circuitry therein, a second housing locating navigation circuitry therein having a finger actuated navigation input, and a coupling housing arranged to selectively couple the first and second housings together so as to remain readily separable from one another.

This application claims the benefit under 35 U.S.C.119(e) of U.S. provisional application Ser. No. 61/696,896, filed Sep. 5, 2012 and U.S. provisional application Ser. No. 61/731,805, filed Nov. 30, 2012.

### FIELD OF THE INVENTION

The present invention relates to an interactive gaming system including a gaming console arranged to generate computer animated effects in a virtual play environment and a controller input for controlling interaction of participants in the virtual play environment in which the controller input for a single participant includes two independent motion tracking circuitries and two independent navigation circuitries.

### BACKGROUND

As shown in FIGS. 1 through 3, the use of motion control in an interactive gaming system typically takes one of three forms:

i) each game participant controls a single controller with motion tracking circuitry and auxiliary finger actuated switches as shown in FIG. 1;

ii) each game participant controls two controllers in which each controller includes motion tracking circuitry along with auxiliary finger actuated switches as shown in FIG. 2;

iii) each game participant controls two controllers in which one controller includes motion tracking circuitry along with auxiliary finger actuated switches and the other controller includes a finger actuated navigation input arranged to receive directional input in two dimensions along with auxiliary finger actuated switches as shown in FIG. 3.

Currently, motion controls have typically been implemented in the following ways:

1) 1 motion controller velocity and acceleration feedback with no camera or character control.

Eg. Wii Sports Tennis, Wii Sports Frisbee, Wii Sports Bowling, Wii Sports Ping-Pong.

2) 1 motion controller velocity and acceleration feedback to control character.

Eg. Mario Kart Wii, Other Driving games.

3) 1 Motion controller as camera control with 1 joystick-navigation controller moving character.

Eg. Killzone 3 PS3, Resistance 3 PS3

4) 1 motion controller in 3d space with no camera or character control.

Eg: PS3 Sports Champions Frisbee, PS3 Sports Champions Ping-Pong

5) 1 motion controller of hand with character and camera control mapped to button selection combined with pointing motion controller.

Eg. Datura PS3

6) 2 motion controller's 3d space feedback with no character or camera control.

Eg. PS3 Sports Champions Archery, Sword Fighting, Volleyball,

7) 1 motion controller as arm with 1 joystick-navigation controller to move character and camera.

Eg. Sorcery PS3

In some interactive gaming systems, the interaction of game participants within the virtual play environment is limited by the types of available controllers such that some of actions of game participants must be performed with inputs which may not be as intuitive to use as desired.

### SUMMARY OF THE INVENTION

According to one aspect of the invention there is provided a control system for use by a respective game participant in an interactive gaming system in which the interactive gaming system comprises a gaming console arranged to execute a gaming program to generate and display computer animated effects in a virtual play environment and to receive commands from the control system to control interaction of the respective game participant with the virtual play environment, the control system comprising at least one controller assembly arranged to be supported by a respective single hand of the game participant, said at least one controller assembly comprising:

motion tracking circuitry including at least one acceleration force sensor so as to be arranged to track motion of the controller assembly including tracking motion in three dimensional space and rotational motion and being arranged to generate a corresponding motion input signal;

navigation circuitry including a finger actuated navigation input arranged to receive directional input in two dimensions and being arranged to generate a corresponding navigation input signal; and

auxiliary circuitry including a plurality of finger actuated auxiliary switches arranged to generate respective auxiliary input signals.

In preferred embodiments, said at least one controller assembly includes a first controller assembly arranged to be supported entirely by a first hand of the game participant and a second controller assembly arranged to be supported entirely by a second hand of the same game participant such that each of the first and second controller assemblies includes respective motion tracking circuitry, navigation circuitry, and auxiliary circuitry and such that all of the circuitry of both the first and second controller assemblies are associated with interaction of a single game participant with the virtual play environment.

The control system thus permits a greater number of interactions of a game participant with the virtual environment to be performed in a manner which is more intuitive than with prior single player control systems.

For example:

i) the first navigation input signal may be converted to player movement commands which navigate movement of a virtual representation of the game participant within the virtual play environment:

ii) the second navigation input signal may be converted to camera movement commands which navigate a perspective of virtual play environment arranged to be displayed to the game participant; and

iii) the first and second motion input signals may be converted to player arm and hand motion commands which control movement of a virtual representation of both arms and hands of the game participant in the virtual play environment.

Preferably the finger actuated navigation input comprises a joystick, a D-pad, or both.

Preferably at least one of the auxiliary switches of said at least one controller assembly comprises a pressure sensitive trigger switch.

Preferably each controller assembly comprises:

a first housing supporting the motion tracking circuitry therein;

a second housing independent of the first housing and supporting the navigation circuitry therein; and

a coupling assembly arranged to couple the first and second housings together such that the first and second housings are selectively separable from one another.

When the first housing includes at least one light source thereon which is identifiable by a motion tracking system of the gaming system, the coupling assembly may further include at least one auxiliary light supported thereon which is identifiable by the motion tracking system of the gaming system similarly to said at least one light source.

Preferably some of the auxiliary switches are located on each of the first and second housings of each controller assembly.

Preferably at least one of the auxiliary switches on the first housing of each controller assembly comprises a pressure sensitive trigger switch.

Preferably each of the first and second housings of each controller assembly are elongate in a longitudinal direction and the coupling assembly couples the first and second housings to one another such that the housings are spaced apart and such that the longitudinal directions are parallel to one another.

Preferably the coupling assembly couples the first and second housings spaced apart from one another such that the fingers of the hand of the game participant are arranged to be received between the first and second housings when the hand of the game participant is gripped about the first housing.

Preferably the control system is used in combination with an auxiliary control scheme in which control scheme is executable by the gaming console within the gaming program so as to convert the input signals from the controller assembly to commands which control interaction of the associated game participant.

In some embodiments the auxiliary control scheme corresponds to each game participant including only a single controller assembly associated therewith. In this instance the auxiliary control scheme is arranged such that the navigation input signal is converted to game participant movement commands which navigate movement of a virtual representation of the game participant within the virtual play environment.

In further embodiments, the auxiliary control scheme corresponds to each game participant including a first controller assembly and a second controller assembly associated therewith for being supported in respective first and second hands of the game participant. In this instance the auxiliary control scheme is arranged such that the navigation input signal of the first controller assembly is converted to game participant movement commands which navigate movement of a virtual representation of the game participant within the virtual play environment and the navigation input signal of the second controller assembly is converted to camera movement commands which navigate a perspective of virtual play environment arranged to be displayed to the game participant.

The gaming console may be further arranged to execute the gaming program such that the motion input signal of the first controller assembly is converted to game participant arm motion commands which control movement of a virtual representation of a first arm of the game participant in the virtual play environment and such that the motion input signal of the second controller assembly is converted to game participant arm motion commands which control movement of a virtual representation of a second arm of the game participant in the virtual play environment.

Preferably the auxiliary control scheme is arranged such that the game participant arm motion commands comprise hand and arm motion commands representing a 1 to 1 motion control ratio between movement of the hands and arms of the game participant and resulting movement of a virtual representation of hands and arms of the game participant in the virtual play environment.

The control system is preferably used with a gaming program also including a default control scheme and a default control assembly arranged to generate commands for controlling interaction of a respective game participant with the virtual play environment according to the default control scheme of the gaming program. In this instance, the auxiliary control scheme is preferably arranged to only be executable by the gaming console within the gaming program in response to an activation code.

The activation code may comprise a unique code associated with each controller assembly.

Preferably the activation code is arranged to be storable on the gaming console and the gaming program includes an authorization algorithm arranged to: i) determine if the activation code is stored on the gaming console upon each activation of the gaming program, and ii) activate the auxiliary control scheme in response to the activation code being stored on the gaming console.

The authorization algorithm may be further arranged to execute the gaming program with the default control scheme being enabled and the auxiliary control scheme being disabled in response to an absence of an activation code being stored on the gaming console.

The authorization algorithm may be further arranged to prompt the gaming participant to purchase an activation code through an online store in response to determination that there is no activation code stored on the gaming console.

According to a second aspect of the present invention there is provided a gaming program arranged for execution on a gaming console to generate and display computer animated effects in a virtual play environment and to receive commands from any one of a plurality of peripheral control devices of different configuration from one another to control interaction of a respective game participants with the virtual play environment, the gaming program comprising:

a control scheme associated with each of the plurality of peripheral control devices in which the control scheme defines a conversion of the input signals from the respective peripheral control device to the commands which control the interaction of the associated game participant with the virtual play environment, the control schemes including:
a default control scheme arranged to generate commands which control interaction of the game participant with the virtual play environment using a default peripheral control device of the gaming console; and
at least one auxiliary control scheme arranged to generate commands which control interaction of the game participant with the virtual play environment using an auxiliary peripheral control device in place of the default peripheral control device of the gaming console;
said at least one auxiliary control scheme being arranged to only be executable by the gaming console within the gaming program in response to an activation code.

According to the second aspect of the present invention, the activation code is preferably arranged to be storable on the gaming console. In this instance, the gaming program preferably further comprises an authorization algorithm arranged to determine if the activation code is stored on the gaming console upon each execution of the gaming program on the gaming console and activate the auxiliary control scheme in response to the activation code being stored on the gaming console.

According to a further aspect of the present invention there is provided an interactive gaming system comprising:

a gaming console arranged to execute a gaming program to generate and display computer animated effects in a virtual play environment and to receive commands from at least one game participant to control interaction of the respective game participant with the virtual play environment;

a control system associated with said at least one game participant, the control system comprising:

i) a first controller assembly arranged to be supported by a first hand of the game participant, the first controller comprising:
a) motion tracking circuitry including at least one acceleration force sensor so as to be arranged to track motion of the first controller assembly including tracking motion in three dimensional space and rotational motion and being arranged to generate a corresponding first motion input signal;
b) navigation circuitry including a finger actuated navigation input arranged to receive directional input in two dimensions and being arranged to generate a corresponding first navigation input signal; and
c) auxiliary circuitry including a plurality of finger actuated auxiliary switches arranged to generate respective auxiliary input signals; and

ii) a second controller assembly arranged to be supported by a second hand of the game participant, the second controller comprising:
a) motion tracking circuitry including at least one acceleration force sensor so as to be arranged to track motion of the second controller assembly including tracking motion in three dimensional space and rotational motion and being arranged to generate a corresponding second motion input signal;
b) navigation circuitry including a finger actuated navigation input arranged to receive directional input in two dimensions and being arranged to generate a corresponding second navigation input signal;
c) auxiliary circuitry including a plurality of finger actuated auxiliary switches arranged to generate respective auxiliary input signals;

the gaming console being arranged to execute the gaming program so as to convert the input signals from both the first and second controllers to commands which control interaction of the associated game participant commonly associated with both the first and second controllers.
One embodiment of the invention will now be described in conjunction with the accompanying drawings in which:

### BRIEF DESCRIPTION OF THE DRAWINGS

FIG. 1 is a schematic representation of a prior art gaming control system in which each game participant uses one motion controller;
FIG. 2 is a schematic representation of another prior art gaming control system in which each game participant uses two motion controllers;

FIG. 3 is a schematic representation of another prior art gaming control system in which each game participant uses one motion controller and one joystick navigation controller;
FIG. 4 is a schematic representation of the gaming control system according to the present invention in which each game participant uses two motion controllers and two joystick navigation controllers;

FIG. 5 is an exploded perspective view of one of the control assemblies according to the gaming control system of FIG. 4;
FIG. 6 is a perspective view of one assembled control assembly according to the gaming control system of FIG. 4;

FIG. 7 is a side elevational view of one of the coupling assembly of one of the control assemblies according to the gaming control system of FIG. 4;

Figure is a perspective view demonstrating a 1 to 1 motion control ratio between movement of the hands and arms of the game participant and resulting movement of a virtual representation of hands and arms of the game participant in the virtual play environment;

FIGS. 9A through 9C are a comparison chart between the gaming control system of present invention and the gaming control systems of FIGS. 1 through 3;

FIG. 10 is a schematic representation of the gaming system;
FIG. 11 is a simplified schematic representation of the gaming control system according to FIG. 4 in which each game participant uses two motion controllers and two joystick navigation controllers;
FIG. 12 is a flow chart representing an authorization algorithm of the gaming program for activating use of the gaming control system of the present invention;

FIG. 13A and FIG. 13B are side elevational and top plan views of a lower portion of the coupling assembly of one control assembly according to the system of FIG. 4; and

FIGS. 14A through 14E are side elevational, bottom plan, top plan, rear end and front end views respectively of an upper portion of the coupling assembly of one control assembly according to the system of FIG. 4.

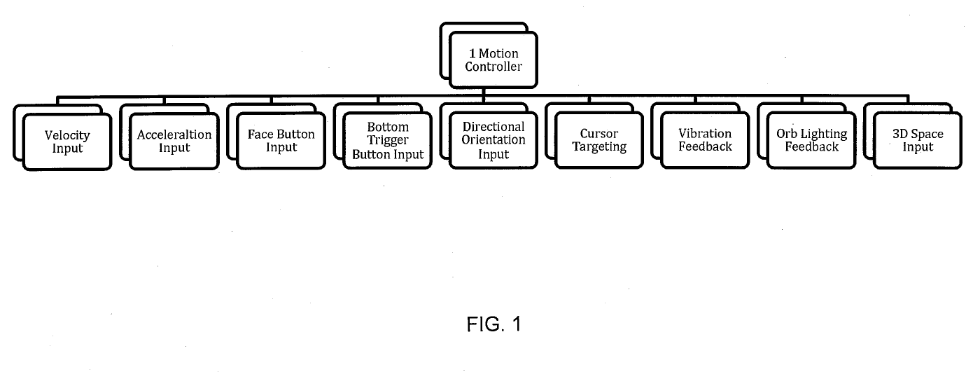

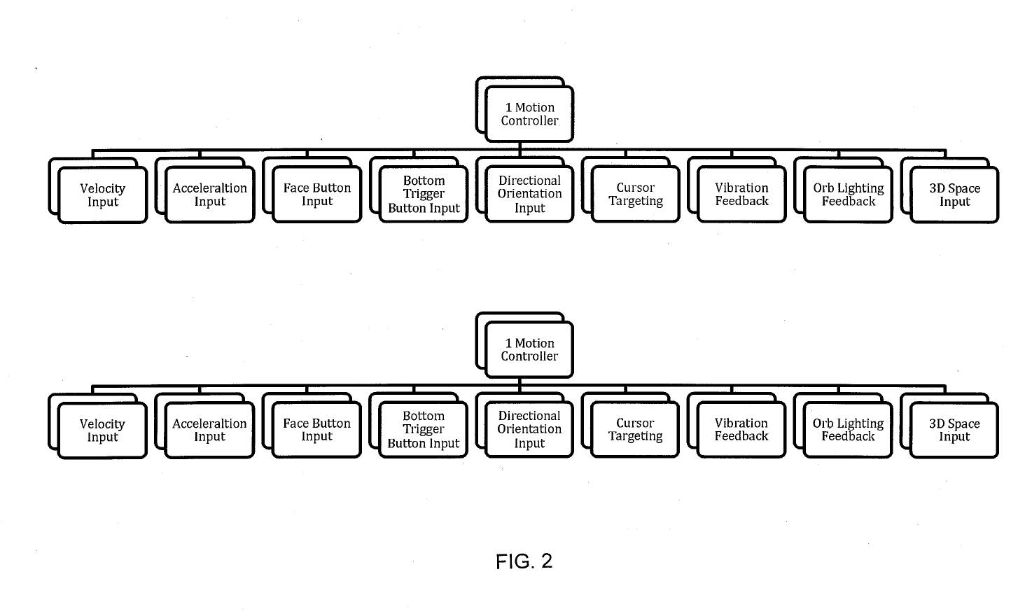

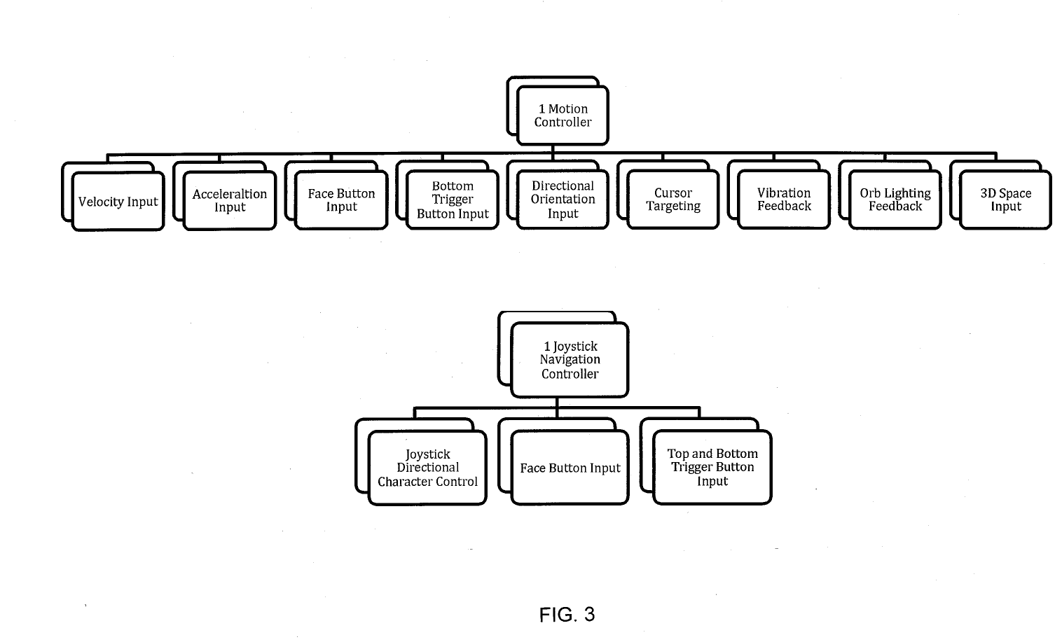

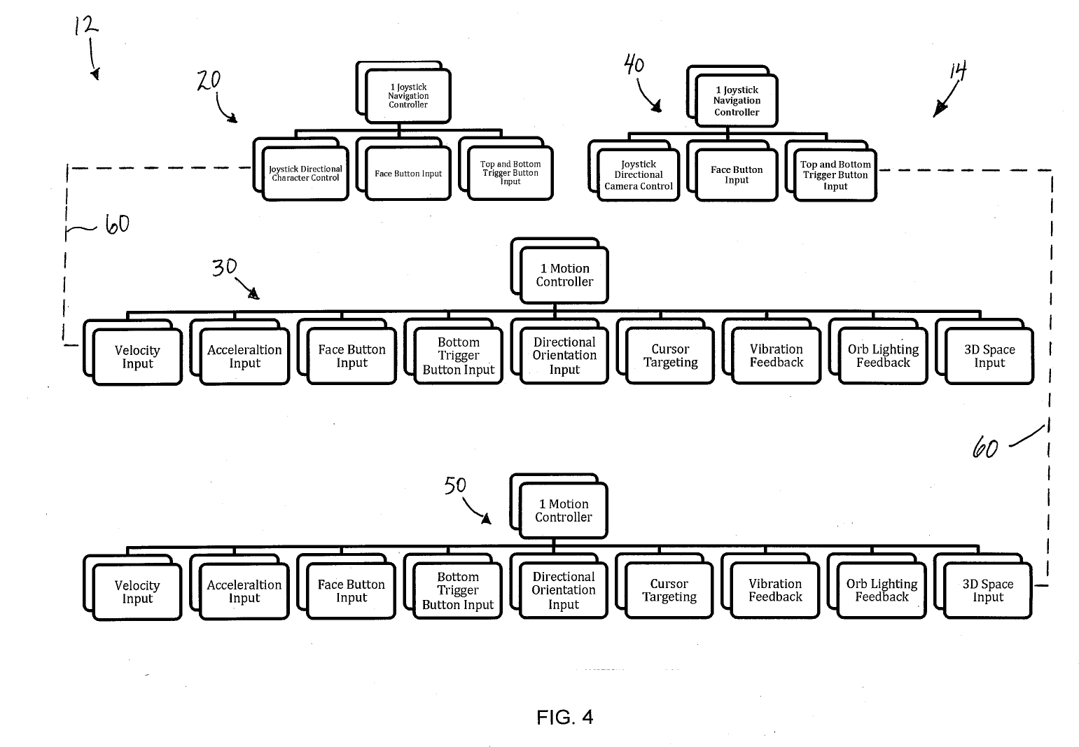

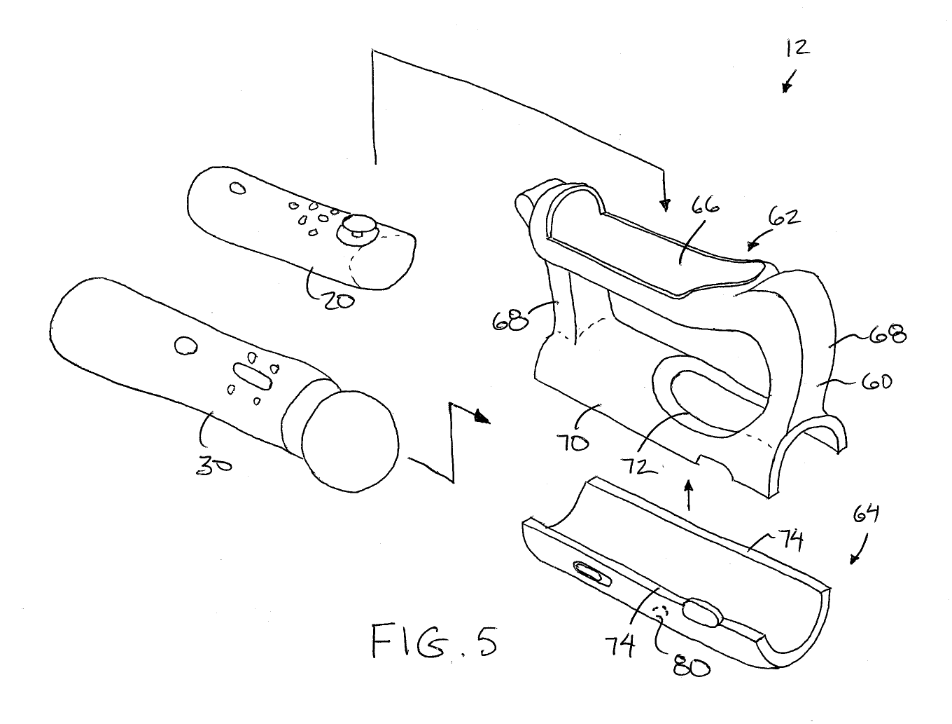

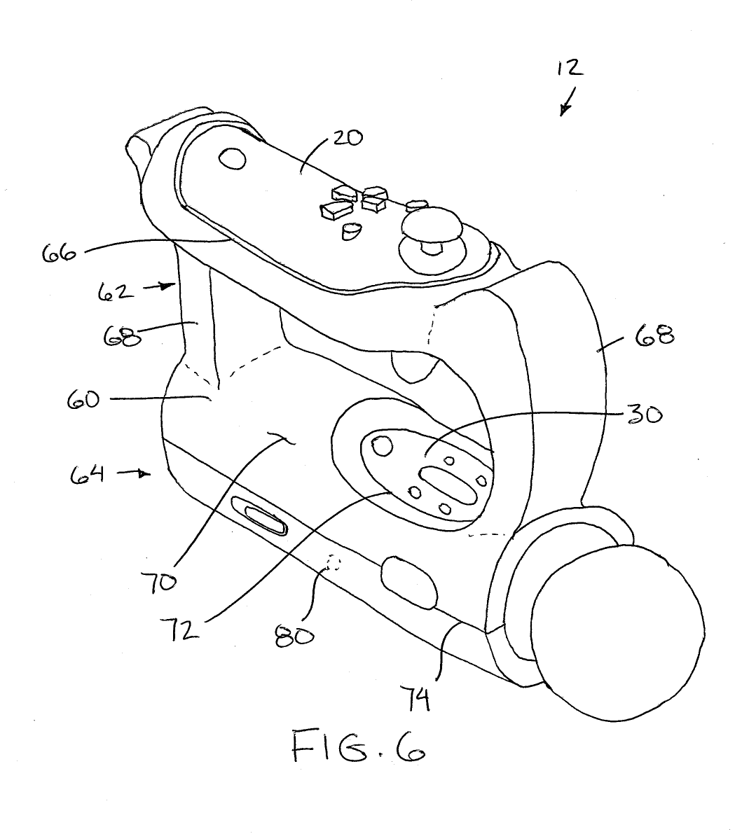

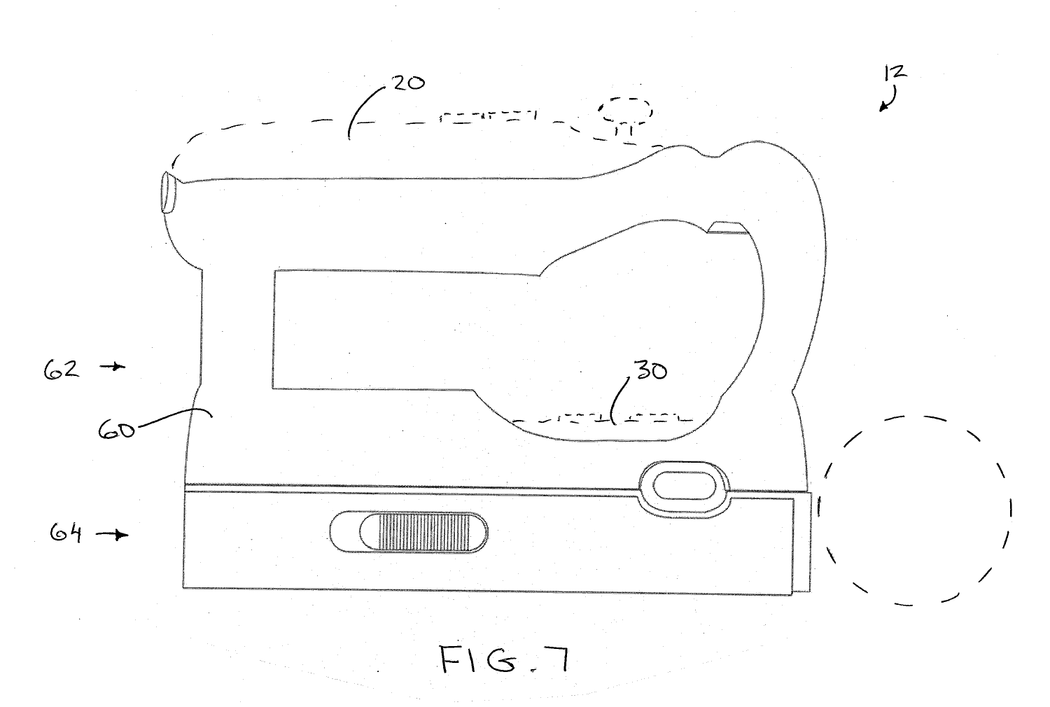

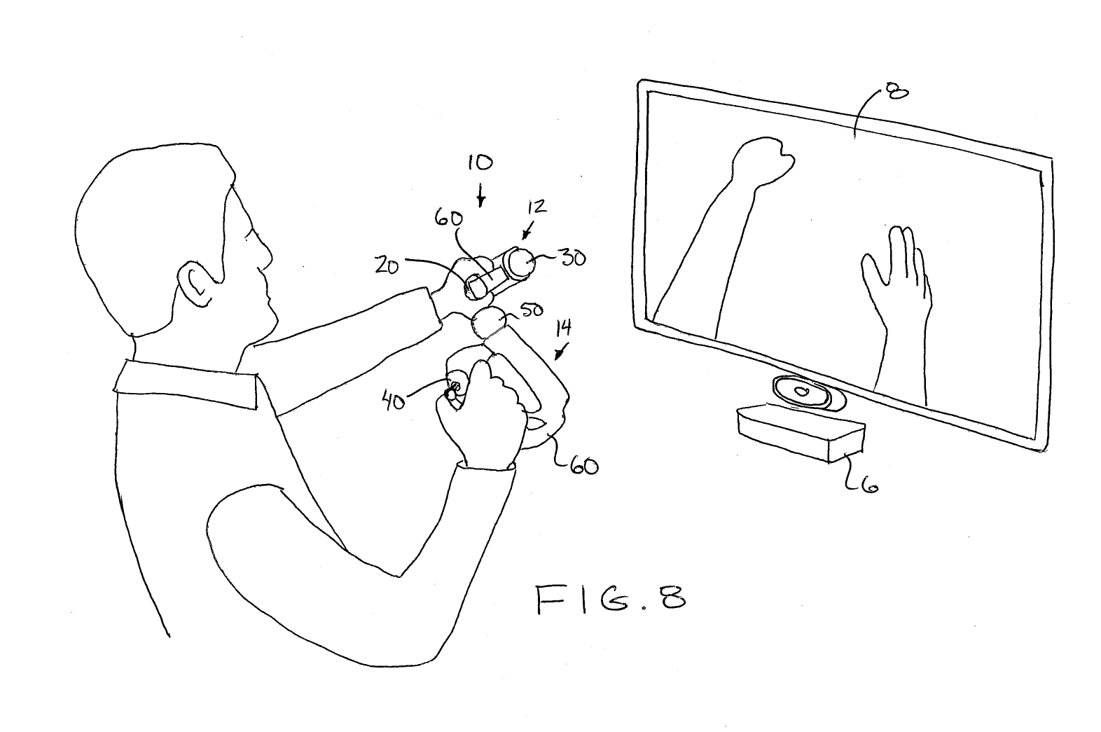

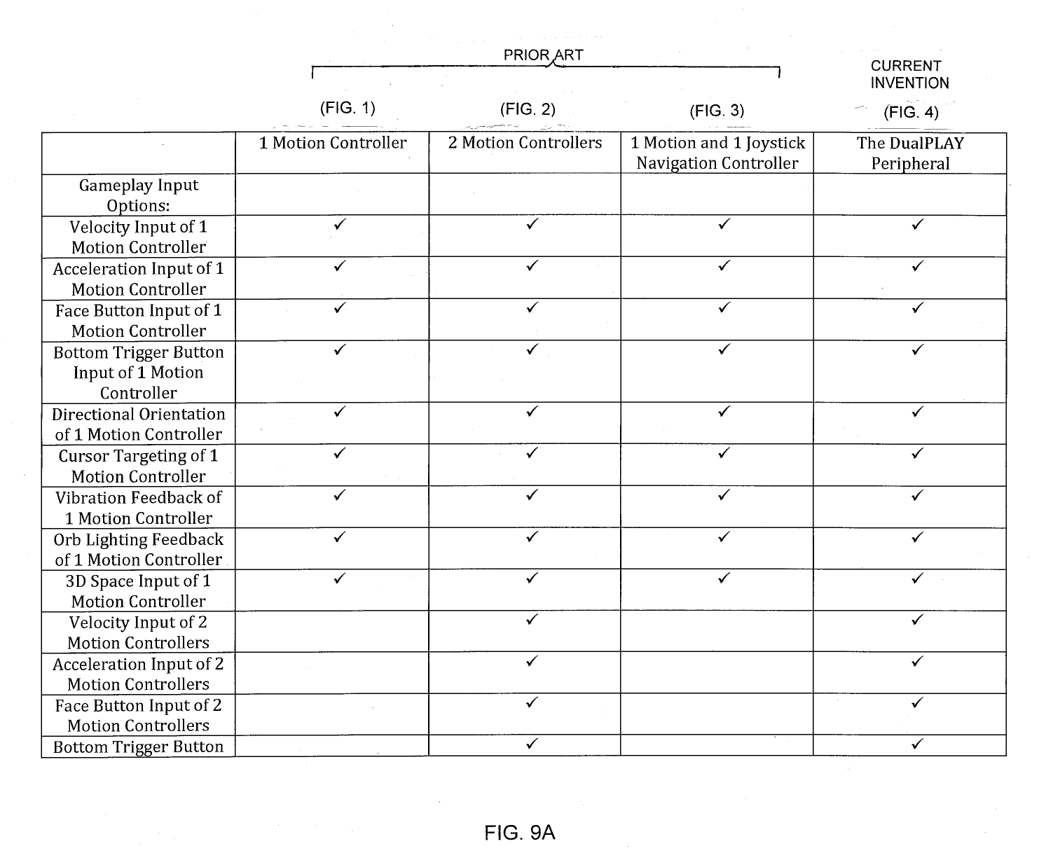

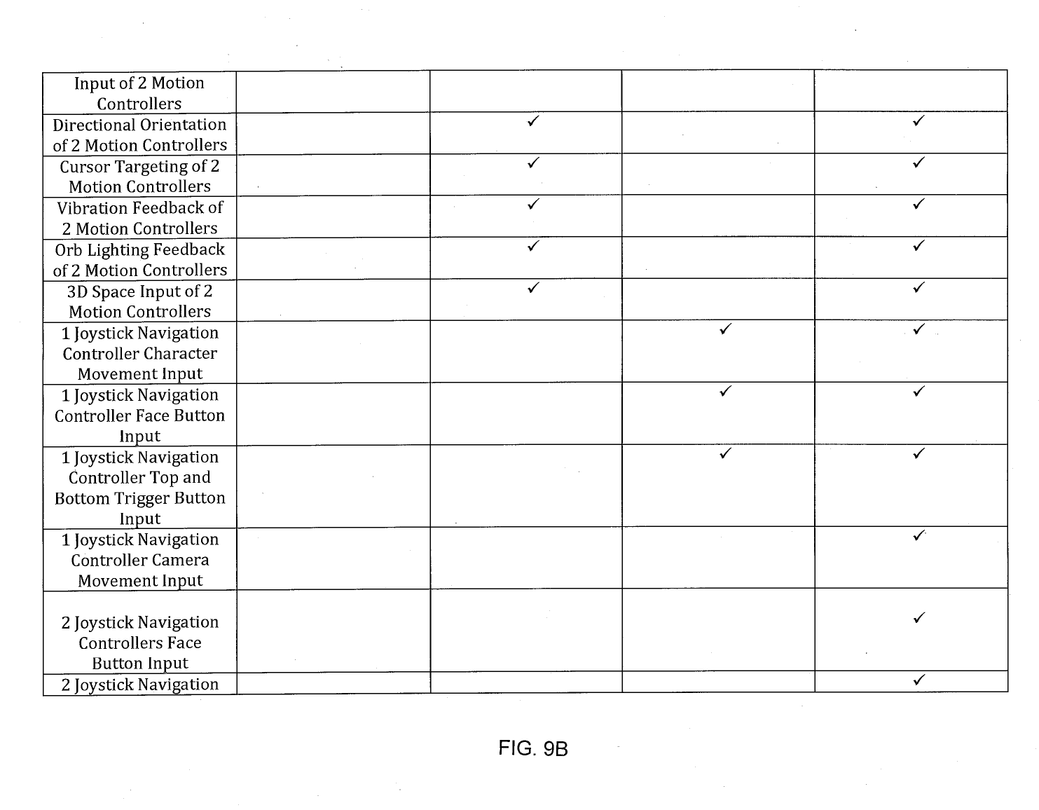

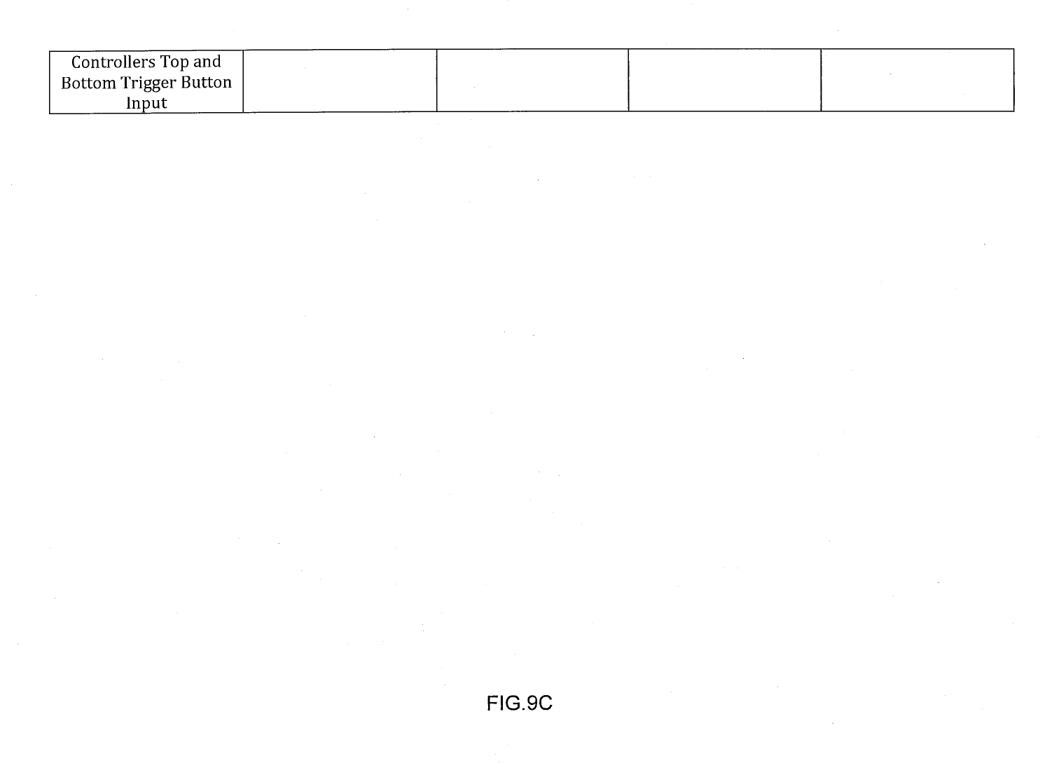

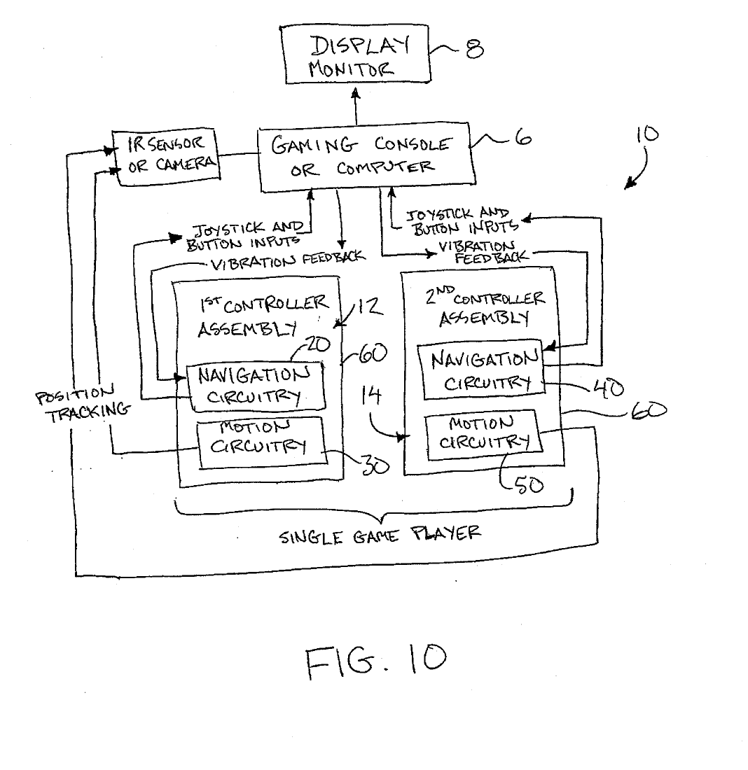

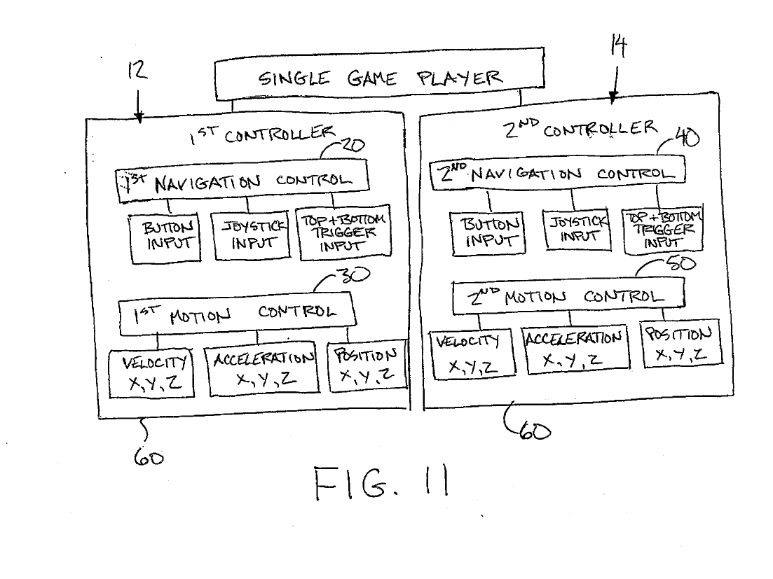

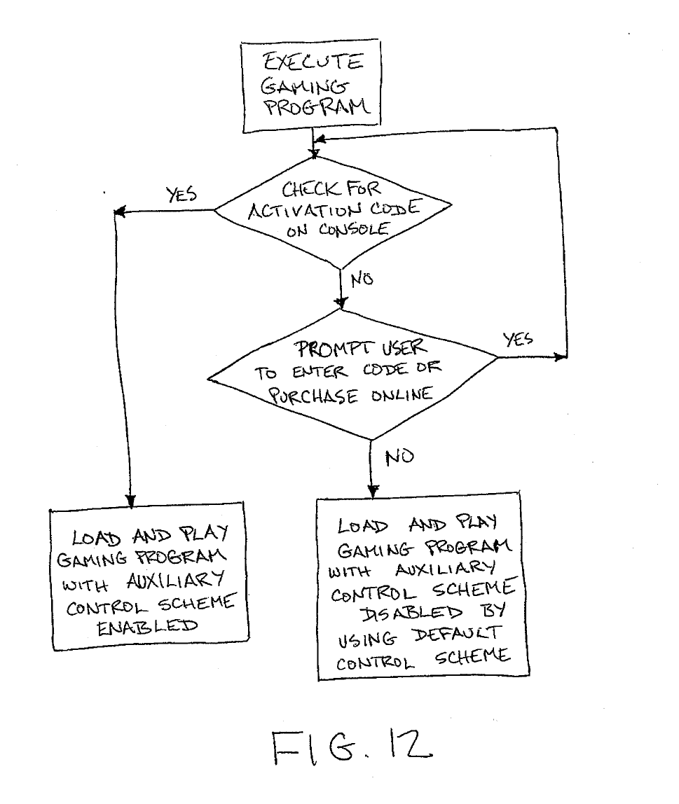

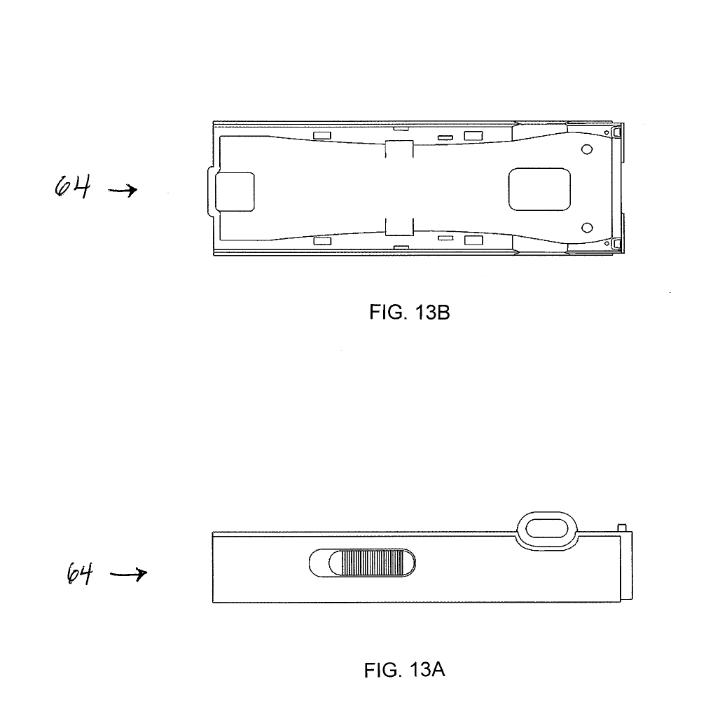

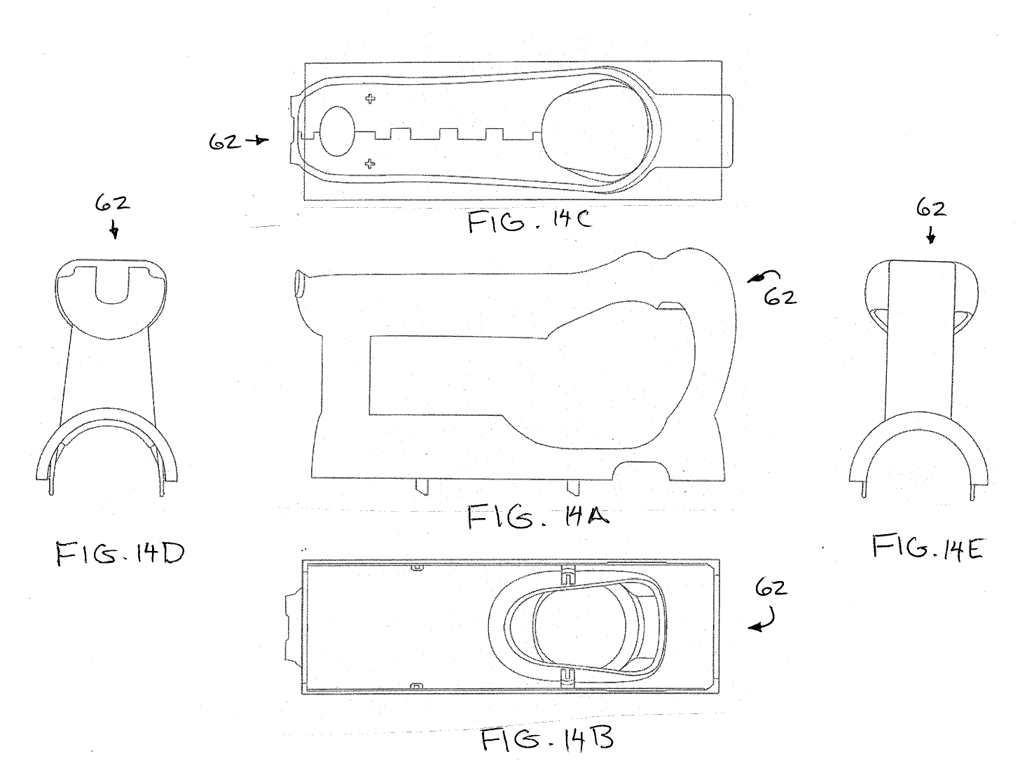

In the drawings like characters of reference indicate corresponding parts in the different figures.

### DETAILED DESCRIPTION

As shown in the accompanying Figures, a control system 10 is provided for use by a single game participant in an interactive gaming system. The interactive gaming system generally includes a gaming console 6 (for example a dedicated gaming device or a personal computer of various forms) arranged to execute a gaming program to generate and display computer animated effects in a virtual play environment on a display device 8 and to receive commands from at least one game participant to control interaction of the respective game participant with the virtual play environment. The control system 10 as described herein is associated with only one of the game participants. Other game participants interact with the virtual play environment with their own respective control system 10.

The control system 10 generally takes the form of one or more peripheral control devices or controller assemblies to be associated with a single game participant. As shown in the illustrated embodiments the control system includes two peripheral control devices identified as a first controller assembly 12 which includes the first housing 20 and the second housing 30, and the second controller assembly 14 which includes the first housing 40 and the second housing 50. In each controller assembly a coupling assembly 60 is arranged to couple the first and second housings together such that the first and second housings are readily separable from one another and readily re-coupled to one another.

The peripherals each house one navigation controller having a first housing above one motion controller having a second housing.

The navigation controller slides down or longitudinally back into and snugly fits into its holder which defines an upper portion 62 of the coupling assembly 60. The upper portion 62 includes a cradle portion 66 that receives the navigation controller therein and a pair of leg portions 68 extending downwardly from opposing ends of the cradle portion. A saddle portion 70 extends between the leg portions, spaced below the cradle portion so as to readily receive the fingers of a user therebetween and such that the longitudinal direction of the cradle portion and saddle portion are generally parallel to one another. The saddle portion 70 is contoured to fit over the top side of the navigation controller and includes a main opening 72 to align with and provide access to controller inputs on the top side of the navigation controller.

The motion controller is placed in a bottom shell which defines a lower portion 64 that can be detached from the upper portion 62. The lower portion 64 defines a cradle structure that is contoured to extend around the bottom side of the motion controller between two opposing side edges 74 which are arranged to be selectively clipped into and held firmly into place in relation to corresponding bottom side edges of the saddle portion 70 of the upper portion 62 of the coupling assembly. The saddle portion 70 of the upper portion and the cradle structure of the lower portion 64 collectively surround the motion controller and support the respective motion controller relative to the respective navigation controller so that the longitudinal direction of the first and second housings are generally parallel and spaced apart.

In further embodiments, the shape of the coupling assembly can be varied to accommodate different shapes and sizes of motion and navigation controllers. In one instance slide in attachments for the different portions of the coupling assembly permit different controllers to fit within a universal coupling assembly.

In further embodiments, LED lights 80 can be positioned on different exterior surfaces of the coupling assembly, for example the bottom and back of the peripheral. The auxiliary lights function as additional points of tracking for a depth sensing camera (PS Eye, PS4 Eye, Xbox 360 Kinect, Xbox One Kinect 2) of a motion tracking system of the gaming system. The auxiliary lights are identifiable by the motion tracking system of the gaming system to allow for continuous positional tracking of the controller even when peripheral positioned so that the main tracking light of the motion controllers which are normally identifiable by the motion tracking system of the gaming system are blocked. The LED lights 80 are powered by built in battery pack or solar strips on side of the coupling assembly.

In further embodiments, the coupling system is used with motion controllers that do not use any light source and instead use a different means of motion control, for example an infrared sensor bar.

The application of using a pair of two peripherals, one in each hand, each equipped with one motion and one joystick-navigation controller enables revolutionary gameplay never seen before in a motion-controlled game.
The peripheral allows for one navigation controller to control the character and one navigation controller to control the camera, at the same time having complete 1:1 motion control of both arms and hands. In order to enable this gameplay scheme you must have both hands equipped with a peripheral containing one joystick-navigation controller and one motion controller, for a total of 4 controllers being used together by one game-player for the first time ever.

According to this first auxiliary control scheme setup, a game participant is enabled the freedom to move their character through the game environment in a familiar and comfortable way, as if using a regular dual-analog joystick controller, but with the new ability to move their arms and have their character mimic their exact hand movements to interact with the objects of a game-world in an extremely realistic and completely natural way.

The new controller scheme also allows for additional buttons to be used in the game for more gameplay options, such as closing your characters hands by squeezing the bottom trigger buttons on the left and right joystick-navigation controllers, while still having the option to use the top trigger buttons to use the object that is being held in the characters hand, at the same time using the D-Pad on the left and right joystick-navigation controllers to change items that are held in the left and right hands of the game character.

More particularly, the first auxiliary control scheme is arranged to be executed by the gaming console within the gaming program so as to convert the input signals from two controller assemblies to commands which control interaction of a single associated game participant. The first auxiliary control scheme is arranged such that the navigation input signal of the first controller assembly is converted to game participant movement commands which navigate movement of a virtual representation of the game participant within the virtual play environment and the navigation input signal of the second controller assembly is converted to camera movement commands which navigate a perspective of virtual play environment arranged to be displayed to the game participant.

In further embodiments however, a second auxiliary control scheme may be provided corresponding to the use of a single controller assembly according to the present invention which includes a first housing 20, a second housing 30 and a coupling assembly 60 coupled therebetween. Similarly to the previous embodiment, this second auxiliary control scheme is also executable by the gaming console within the gaming program so as to convert the input signals from said at least one controller assembly to commands which control interaction of the associated game participant associated with the controller assembly. More particularly, the second auxiliary control scheme is arranged such that the navigation input signal is converted to game participant movement commands which navigate movement of a virtual representation of the game participant within the virtual play environment.

In either instance, the first and second auxiliary control schemes are typically provided in addition to one or more default control schemes included within a gaming program to be executed on the gaming console or computer. The gaming console or computer is typically arranged for use with a plurality of peripheral input devices or controller assemblies including default input devices and the new controller system described herein.

The gaming program includes a control scheme associated with each of the plurality of peripheral control devices in which each control scheme defines a conversion of the input signals from the respective peripheral control device to the commands which control the interaction of the associated game participant with the virtual play environment. Accordingly the control schemes included in the gaming program include one or more default control schemes arranged to generate commands which control interaction of the game participant with the virtual play environment using respective default peripheral control devices of the gaming console. The control schemes also included the first and second auxiliary control schemes described above. The auxiliary control schemes are arranged to generate commands which control interaction of the game participant with the virtual play environment using the auxiliary peripheral control devices 12 and 14 in place of the default peripheral control device of the gaming console.

The auxiliary control schemes are arranged to only be executable by the gaming console within the gaming program in response to an activation code which is in the form of a unique code associated with a respective controller. The activation code can be obtained by being included with the purchase of the associated auxiliary peripheral device or can be arranged for purchase through on online store. Once the game participant has a valid activation code, the code is arranged to be storable on the gaming console.

As represented schematically in FIG. 12, the gaming program includes an authorization algorithm arranged to determine if the activation code is stored on the gaming console upon each activation of the gaming program. The authorization algorithm is arranged to activate the auxiliary control scheme and subsequently load the gaming program to be played with a user with the auxiliary control scheme being enabled in response to the activation code being stored on the gaming console.

If no code is stored on the console, the authorization algorithm may be further arranged to prompt the gaming participant to purchase an activation code through an online store or prompt the user to enter a code which has already been obtained with purchase of the auxiliary peripheral device. If the user declines to enter or purchase the activation code once prompted, the authorization algorithm is then arranged to execute the gaming program so that it is playable by the game participant, but with only the default control schemes being enabled and the auxiliary control schemes being disabled.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A control system for use by a respective game participant in an interactive gaming system in which the interactive gaming system comprises a gaming console arranged to execute a gaming program to generate and display computer animated effects in a virtual play environment and to receive commands from the control system to control interaction of the respective game participant with the virtual play environment, the control system comprising at least one controller assembly arranged to be supported by a respective single hand of the game participant, said at least one controller assembly comprising:
motion tracking circuitry including at least one acceleration force sensor so as to be arranged to track motion of the controller assembly including tracking motion in three dimensional space and rotational motion and being arranged to generate a corresponding motion input signal;
navigation circuitry including a finger actuated navigation input arranged to receive directional input in two dimensions and being arranged to generate a corresponding navigation input signal; and
auxiliary circuitry including a plurality of finger actuated auxiliary switches arranged to generate respective auxiliary input signals.

2. The control system according to claim 1 wherein said at least one controller assembly includes a first controller assembly arranged to be supported entirely by a first hand of the game participant and a second controller assembly arranged to be supported entirely by a second hand of the same game participant such that each of the first and second controller assemblies includes respective motion tracking circuitry, navigation circuitry, and auxiliary circuitry and such that all of the circuitry of both the first and second controller assemblies are associated with interaction of a single game participant with the virtual play environment.

3. The control system according to claim 1 wherein the finger actuated navigation input comprises a joystick, a D-pad, or both.

4. The control system according to claim 1 wherein at least one of the auxiliary switches of said at least one controller assembly comprises a pressure sensitive trigger switch.

5. The control system according to claim 1 wherein said at least one controller assembly comprises:
a first housing supporting the motion tracking circuitry therein;
a second housing independent of the first housing and supporting the navigation circuitry therein; and
a coupling assembly arranged to couple the first and second housings together such that the first and second housings are selectively separable from one another.

6. The control system according to claim 5 wherein at least one of the auxiliary switches on the first housing of said at least one controller assembly comprises a pressure sensitive trigger switch.

7. The control system according to claim 5 wherein each of the first and second housings of said at least one controller assembly are elongate in a longitudinal direction and wherein the coupling assembly of said at least one controller assembly couples the first and second housings said at least one controller assembly to one another such that the housings are spaced apart and such that the longitudinal directions are parallel to one another.

8. The control system according to claim 7 wherein the coupling assembly of said at least one controller assembly couples the first and second housings of said at least one controller assembly spaced apart from one another such that the fingers of the hand of the game participant are arranged to be received between the first and second housings when said hand of the game participant is gripped about the first housing.

9. The control system according to claim 5 wherein the first housing includes at least one light source thereon which is identifiable by a motion tracking system of the gaming system and wherein the coupling assembly includes at least one auxiliary light supported thereon which is identifiable by the motion tracking system of the gaming system similarly to said at least one light source.

10. The control system according to claim 1 in combination with an auxiliary control scheme which is executable by the gaming console within the gaming program so as to convert the input signals from said at least one controller assembly to commands which control interaction of the associated game participant associated with said at least one controller assembly, wherein the auxiliary control scheme corresponds to each game participant including only a single controller assembly associated therewith, the auxiliary control scheme being arranged such that the navigation input signal is converted to game participant movement commands which navigate movement of a virtual representation of the game participant within the virtual play environment.

11. The control system according to claim 1 in combination with an auxiliary control scheme which is executable by the gaming console within the gaming program so as to convert the input signals from said at least one controller assembly to commands which control interaction of the associated game participant associated with said at least one controller assembly, wherein the auxiliary control scheme corresponds to each game participant including a first controller assembly and a second controller assembly associated therewith, the auxiliary control scheme being arranged such that the navigation input signal of the first controller assembly is converted to game participant movement commands which navigate movement of a virtual representation of the game participant within the virtual play environment and the navigation input signal of the second controller assembly is converted to camera movement commands which navigate a perspective of virtual play environment arranged to be displayed to the game participant.

12. The control system according to claim 11 wherein the control scheme is arranged such that the motion input signal of the first controller assembly is converted to game participant arm motion commands which control movement of a virtual representation of a first arm of the game participant in the virtual play environment and such that the motion input signal of the second controller assembly is converted to game participant arm motion commands which control movement of a virtual representation of a second arm of the game participant in the virtual play environment.

13. The control system according to claim 12 wherein the auxiliary control scheme is arranged such that the game participant arm motion commands comprise hand and arm motion commands representing a 1 to 1 motion control ratio between movement of the hands and arms of the game participant and resulting movement of a virtual representation of hands and arms of the game participant in the virtual play environment.

14. The control system according to claim 10 for use a gaming program including a default control scheme and a default control assembly arranged to generate commands for controlling interaction of a respective game participant with the virtual play environment according to the default control scheme of the gaming program, wherein the auxiliary control scheme is arranged to only be executable within the gaming program by the gaming console in response to an activation code.

15. The control system according to claim 14 wherein the activation code comprises a unique code associated with said at least one controller assembly.

16. The control system according to claim 14 in combination with the gaming program wherein the activation code is arranged to be storable on the gaming console and wherein the gaming program includes an authorization algorithm arranged to determine if the activation code is stored on the gaming console upon each activation of the gaming program, the authorization algorithm being further arranged to activate the auxiliary control scheme in response to the activation code being stored on the gaming console.

17. The control system according to claim 16 wherein the authorization algorithm is arranged to execute the gaming program with the default control scheme being enabled and the auxiliary control scheme being disabled in response to an absence of an activation code being stored on the gaming console.

18. The control system according to claim 16 wherein the authorization algorithm is further arranged to prompt the gaming participant to purchase an activation code through an online store in response to determination that there is no activation code stored on the gaming console.

19. A gaming program arranged for execution on a gaming console to generate and display computer animated effects in a virtual play environment and to receive commands from any one of a plurality of peripheral control devices of different configuration from one another to control interaction of a respective game participants with the virtual play environment, the gaming program comprising:
a control scheme associated with each of the plurality of peripheral control devices in which the control scheme defines a conversion of the input signals from the respective peripheral control device to the commands which control the interaction of the associated game participant with the virtual play environment, the control schemes including:
a default control scheme arranged to generate commands which control interaction of the game participant with the virtual play environment using a default peripheral control device of the gaming console; and
at least one auxiliary control scheme arranged to generate commands which control interaction of the game participant with the virtual play environment using an auxiliary peripheral control device in place of the default peripheral control device of the gaming console;
said at least one auxiliary control scheme being arranged to only be executable by the gaming console within the gaming program in response to an activation code.

20. The gaming program according to claim 19 wherein the activation code is arranged to be storable on the gaming console and wherein the gaming program further comprises an authorization algorithm arranged to determine if the activation code is stored on the gaming console upon each execution of the gaming program on the gaming console, the authorization algorithm being further arranged to activate the auxiliary control scheme in response to the activation code being stored on the gaming console.
